(19) United States
(12) Patent Application Publication
(10) Pub. No.: US 2014/0370176 A1
(43) Pub. Date: Dec. 18, 2014

(54) PAN, SYSTEM AND METHOD OF COOKING

(71) Applicants: Mamoru Imura, Nishinomiya Hyogo (JP); Michael Johnson, Holt, MO (US)

(72) Inventors: Mamoru Imura, Nishinomiya Hyogo (JP); Michael Johnson, Holt, MO (US)

(21) Appl. No.: 14/368,009

(22) PCT Filed: Dec. 24, 2012
(86) PCT No.: PCT/US12/71583

§ 371 Date: Jun. 23, 2014

Related U.S. Application Data
(60) Provisional application No. 61/580,072, filed on Dec. 23, 2011.

(51) Int. Cl. A47J 27/04; A47J 36/06

(52) U.S. Cl. CPC A47J 27/04; A47J 36/06; A47J 2027/043
USPC 426/523; 126/377.1; 220/573.1

(57) ABSTRACT

A cookware object, system and method of cooking are provided. The cookware object includes raised ridges and recessed channels within a base of the object that is designed to hold water (or other liquid), and a lid to retain/promote steam.

### CROSS-REFERENCE TO RELATED APPLICATIONS

This application, claims priority to co-pending U.S. Provisional Patent Application Ser. No, 61/1580,072, filed Dec. 23, 2011, the entire disclosure of which is incorporated herein by reference.

### FIELD OF THE INVENTION

The present invention relates generally to the field of cookware. More particularly, the present invention relates to a cookware object, system and method of steam cooking using a cookware object.

### BACKGROUND OF THE INVENTION

Cooking is often referred to as an art, not only because of the combination of ingredients that two into a particular recipe, but also due to the skill necessary for proper application and infusion of varying levels of heat over a given period of time throughout the different phases of the food preparation process. Traditional cookware appliances, such as ovens (microwave ovens being an exception), grills, heat lamps and stoves, all utilize the thermodynamic process of conduction to transfer heat from the outer surface of the food item to its interior. This is generally true regardless of the type of heat source used to heat the surface of the food, be it a radiation heat source(i.e. a heat lamp), conduction heat source (i.e. a stovetop), or a convection heat source (i.e., a convection oven or a food dehydrator).

A pressure cooker is a cookware object such as a pot that includes an airtight lid that seals and locks to the main body of the pot. Food items are placed in the pressure cooker along with liquid (usually water) and the pressure cooker is heated, typically by placing the pressure cooker on the hob of a stovetop appliance. As the liquid temperature rises, the liquid boils creating steam. The steam is trapped within the pressure cooker by the sealed lid, causing the pressure within the pot to increase. As the pressure increases, the temperature at which the liquid will boil increases resulting in a higher cooking temperature within the pot. This increased cooking temperature reduces cooking time from that obtained by boiling water at atmospheric pressure in unsealed cookware. In addition, steam has a much higher heat transfer potential than a liquid at the same temperature, further decreasing cooking time. A secondary benefit of the increased pressure is that it softens the fibers in foods, tenderizing the food. The increased internal temperature, steam and tenderization of foods cooked under pressure combine to decrease by two-thirds or more of the normal cooking times.

In addition to utilizing a pressure cooker, it is also common to steam-cook items in a manner similar to that of a pressure cooker with more standard cookware (such as a pot or a pan) that includes a non-locking lid or cover. Such methods achieve many of the benefits of a pressure cooker, such as increased pressure and most-importantly, generation and retention of steam within the cookware. Because the lid is not locked, the pressure achieved with more standard cookware is not as high as in a pressure cooker, but an increased pressure, compared to that of an uncovered cookware object, often can still be achieved when. a non-vented cover/lid is utilized that includes a vapor seal with the cookware object.

Although standard pots and pans, as well as pressure cookers, are often utilized for steam-cooking food, the generally flat, smooth bottom surfaces of such cookware results in the food being located in the water or other fluid that is added to the interior of the cookware to promote steam. This can be undesirable for many types of food, and thus can result in a cook choosing not to steam-cook at all and/or to steam-cook with a lesser amount of liquid that might otherwise be ideal for promoting steam. Therefore, it would be beneficial to provide a system and method of steam-cooking that allows for use of sufficient liquid while at the same time separating the liquid from the food being cooked.

Many grill pans have been developed that include raised ridges and recessed channels to allow grease and other liquids to drip and drain away from food items being cooked. The channels and ridges of such items are not designed to promote steaming within the cookware object, and typically are utilized without a lid, or with vented lids to prevent steam buildup within the interior of the cookware object. Therefore, it would be beneficial to provide a system and method of steam-cooking.

### SUMMARY OF THE INVENTION

The present invention comprises improved cookware objects, systems and methods for cooking.

The instant invention provides a cookware object, such as a pan, that includes raised ridges and recessed channels within the base of the object designed to hold water (or other suitable liquid), and a lid to retain steam within the vessel, to promote steam cooking. In some embodiments, the lid includes raised ridges and recessed channels within the interior of the lid to promote and/or increase convection and/or steam/air/fluid circulation within the cookware object during cooking.

In some embodiments, the diameter of the vessel, the displacement caused by the grill ridges in the base and the height of the grill ridges in the base are designed to allow for the introduction of sufficient fluid into the vessel to promote steam while cooking, while at the same time separating the food being cooked from the liquid by holding the food on top of the ridges. In some such embodiments, the vessel is designed to hold 250 ML of water at room temperature.

In preferred embodiments, the cookware object is made from multiply stainless steel in a manner similar to that described in U.S. application Ser. No. 10/831,356 filed April 2004, the disclosure of which is incorporated herein by reference in its entirety. In some embodiments, the cookware object includes a vapor seal lid design in which the lid is non-vented and forms a tight seal with a shoulder of the cookware object (as shown at the website www.vitacraft.com and more particularly at http://www.vitacraft.com/pages/features_benefits/features.html, the entire disclosure of the entire site being incorporated by reference herein. In some such embodiments the lid is stainless steel.

In some embodiments, the cookware object includes a marker or other fill indicator to instruct a user on the user on the proper amount of liquid to add to the object promote steam. For example, in some such embodiments, a fill line is etched into the ridges to show the level to which water should be added.

In use, the pan of the instant invention is filled with liquid, such as water to a level below the top of the ridges of the pan. In some embodiments, only a small amount of liquid is utilized, including in some embodiments a spoonful of water. The water essentially functions like a primer for a pump to start the steaming process and bring the natural moisture out of the food item being cooked and allow it to steam cook using its own moisture. A food item to be cooked is placed in the pan on top of the ridges. Because the fluid is below the top of the ridges, the food item is held above and out of (separate from) the fluid. The lid is placed on top of the pan and the pan is placed on a cooktop (such as a stovetop hob) and heated until the fluid is turned into steam. The food item is steamed within the enclosed pan until fully cooked. The lid is then removed and the food item removed from the pan and enjoyed. In other embodiments, the pan and fluid will be heated and steam generated within the enclosed pan before the food item is placed within the pan for cooking.

In some embodiments, the pan of the instant invention is used water or other cooking liquid/fluid is placed in the pan to a level that will fully cover an item to be cooked. The water is brought to a boil and then the pan is removed from the heat source. A zip-pack or other sealed package full of item(s) to be cooked is placed in the pan once the water is brought to boil. The package is left in the cooling water to allow the item(s) to cook.

In some embodiments, the channels are sloped generally downward from the perimeter of the pan inward toward the center of the pan. This aids in distribution of the liquid toward the center of the pan. In other embodiments, the channels are sloped generally downward from the center of the pan outward toward the perimeter, to distribute water/fluid toward the perimeter of the pan. In some embodiments, the interior bottom surface of the pan is generally convex (also called crown or panel). As the pan is heated the crown will result in the bottom flattening out and “hugging” the stovetop burner. In some such embodiments, the channels are sloped generally downward from the center of the pan outward toward the perimeter when the bottom is convex, and will lessen in slope as the bottom flattens. In some such embodiments, the slope will change from generally downward from center toward perimeter when the pan is cool and convex to generally downward from perimeter to center when the pan is heated and bottom is flat.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a schematic of a standard. pan that includes a vapor seal lid design.

FIG. 2a shows a top view of a pan of an embodiment of the instant invention including raised ridges and channels for introducing fluid to promote steam.

FIG. 2b shows a side cross sectional view of the pan shown in FIG. 2a.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

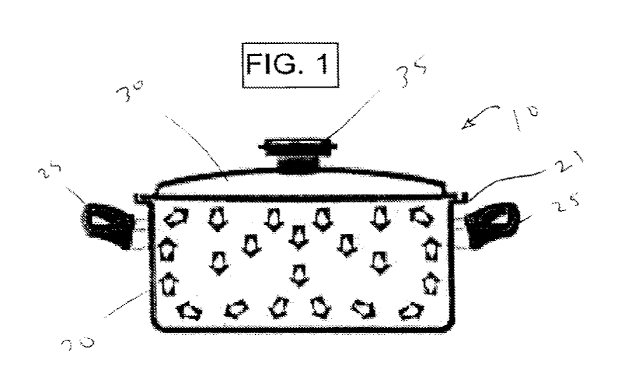

Referring to FIG. 1, a schematic of a standard pan 10 of an embodiment of the instant invention is shown. Pan 10 includes a vapor seal lid design in which the lid 30 is non-vented and forms a tight seal with a shoulder 21 of the base 20 of the cookware object. The pan base 20 includes handles 25, and lid 30 includes a top handle 35. In some embodiments, handle 35 also includes a valve that can be actuated by depression of a button on top of the handle to open the value and release steam/pressure from within the cookware object when the lid 30 is in place on top of the base 20.

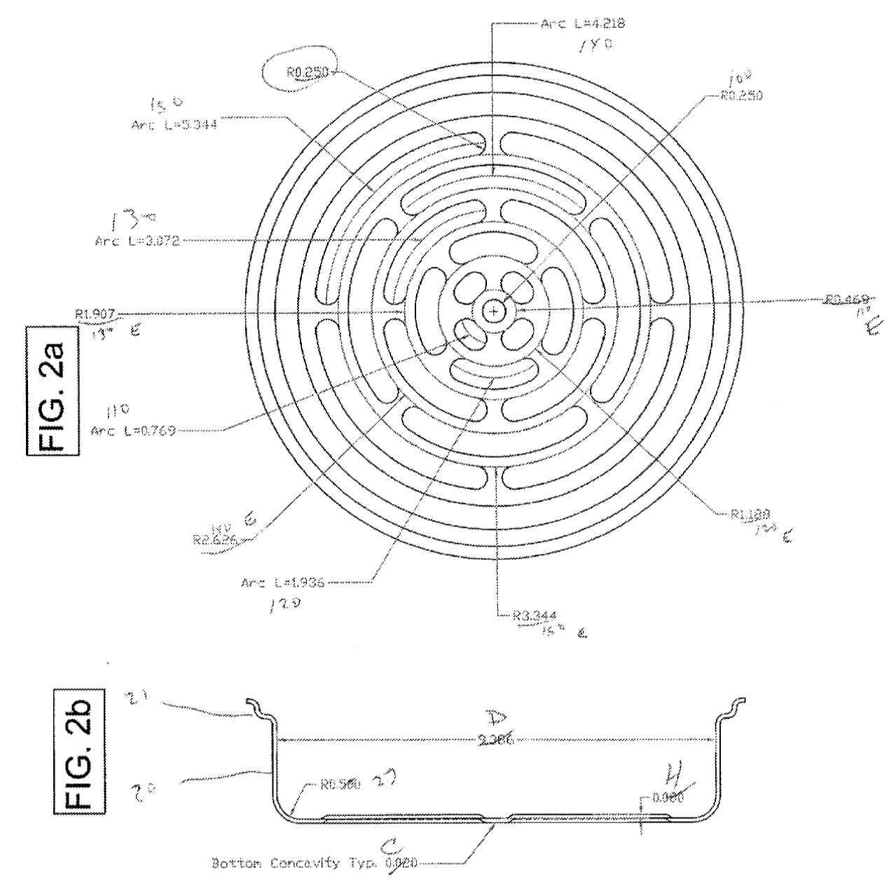

FIG. 2a shows a top view of a pan 10 of an embodiment of the instant invention including raised ridges 100, 110, 120, 130, 140, 150 and channels (between the ridges) in the base 20 for introducing fluid to promote steam. The pan shown in FIG. 2a is designed to introduce 250 ml of water at room temperature. Nevertheless, it will be appreciated that in some embodiments of the method of the instant invention, varying amounts of water (including in some embodiments, a mere spoonful of water) are utilized. In some embodiments, the amount of water is depending upon the amount of moisture inherently or naturally present within the food item being cooked.

FIG. 2b shows a side cross sectional view of the pan 10 shown in FIG. 2a. As is shown in FIG. 2a, the pan base 20 includes a shoulder 21 around the top in which a lid 30 (not shown in FIG. 2a or 2b) is designed to rest. The shoulder 21 and lid 30 work together to form a tight vapor seal for the cookware object during cooking. The pan in some embodiments will also include one or more handles (not shown in FIG. 2a or 2b).

In the embodiment of the pan 10 shown in FIGS. 2a and 2b, the ridges 100, 110, 120, 130, 140, 150 of the base 20 are formed by stamping into the bottom panel of the pan. In this manner, the ridges that protrude upward from the interior surface form recesses on the exterior surface. Nevertheless, it will be appreciated that in alternative embodiments, the ridges are formed through other methods in which the exterior surface of the pan is smooth without any channels.

In one embodiment of the pan 10 shown in FIGS. 2a and 2b, base 20 includes a diameter D of 9.386 inches, with the sides curving up from the bottom of base 20 along a 0.500 inch radius 27. The ridges 100, 110, 120, 130, 140 and 150 include a height H of approximately 0.080 inches measured from the top of each ridge to the original flat interior surface of the bottom portion of base 20. The bottom of base 20 includes a bottom concavity C of approximately 0.020 inches. Ridges 100, 110, 120, 130, 140 and 150 are 6 concentric circles of ridges starting with a single protrusion 100 at the center of base 20 that has a radius of 0.250 inches. Ridges 110 include four arced. elliptical protrusions that each include an arc length of 0.769 inches and radius of 0.250 inches, and are evenly spaced around circle 110E (note that 110E is not visible on the pan itself, it is just a reference line for purposes of demonstrating how the object is manufactured) such that the inner edge of ridges 110 coincide with circle 110E. Circle 110E includes a radius of 0.469 inches from the center of base 20. This creates a channel of approximately 0.219 inches from the outer edge of ridge 100 and the inner edges of ridges 110. Ridges 120 include four arced elliptical protrusions that each include an arc length of 1.936 inches and radius of 0.250 inches, and are evenly spaced around circle 120E (note that 120E is not visible on the pan itself, it is just a reference line for purposes of demonstrating how the object is manufactured) such that the inner edge of ridges 120 coincide with circle 120E. Circle 120E. includes a radius of 1.188 inches from the center of base 20. This creates a channel of approximately 0.219 inches from the outer edge of ridges 110 and the inner edges of ridges 120. Ridges 130 include four arced elliptical protrusions that each include an are length of 3.072 inches and radius of 0.250 inches, and are evenly spaced around circle 130E (note that 130E is not visible on the pan itself, it is just a reference line for purposes of demonstrating how the object is manufactured) such that the inner edge of ridges 130 coincide with circle 130E. Circle 130E includes a radius of 1.907 inches from the center of base 20. This creates a channel of approximately 0.219 inches from the outer edge of ridges 120 and the inner edges of ridges 130. Ridges 140 include four arced elliptical protrusions that each include an arc length of 4.218 inches and radius of 0.250 inches, and are evenly spaced around circle 140E (note that 140E is not visible on the pan itself, it is just a reference line for purposes of demonstrating how the object is manufactured) such that the inner edge of ridges 140 coincide with circle 140E. Circle 150E includes a radius of 2.626 inches from the center of base 20. This creates a channel of approximately 0.219 inches from the outer edge of ridges 130 and the inner edges of ridges 140. Ridges 150 include four arced elliptical protrusions that each include an arc length of 5.344 inches and radius of 0.250 inches, and are evenly spaced around circle 150E (note that 150E is not visible on the pan itself, it is just a reference line for purposes of demonstrating how the object is manufactured) such that the inner edge of ridges 150 coincide with circle 150E. Circle 150E includes a radius of 3.344 inches from the center of base 20. This creates a channel of approximately 0.218 inches from the outer edge of ridge 140 and the inner edges of ridges 150.

In some other embodiments of pan 10 shown in FIGS. 2a and 2b, in which larger or smaller diameters D are utilized, the number of concentric circles or rings of ridges (i.e 6 concentric circles of ridges 100, 110, 120, 130, 140 and 150) and number of protrusions within each set of ridges remains the same, while the thicknesses, spacing and arc lengths may change to accommodate the varying diameter D.

In some embodiments of the instant invention, the lid 30 includes recesses on the inner surface that generally mirror the ridges of pan base 20. In one embodiment of a lid 30 for base 20 of the embodiment shown and described in FIGS. 2a and 2b, the lid 30 includes recesses that generally minor ridges 130, 140 and 140 of the base, by utilizing the same spacing from the center, arc lengths, end radiuses, and thicknesses. In such embodiment ridges 100, 110 and 120 of base 20 are not mirrored so as to accommodate locating the handle 35 on the lid 30. In some embodiments, the recesses in lid 30 are formed by stamping from the bottom panel of the lid. In this manner, the recesses that protrude upward from the interior surface form ridges on the exterior surface of lid 30. Nevertheless, it will be appreciated that in alternative embodiments, the recesses are formed through other methods in which the exterior surface of the lid is smooth without any ridges. In some embodiments, the depth of the recesses formed in lid 30 is less than the height of the mirrored ridges in the pan base 20. In some such embodiments, the depth of the recesses in the lid is substantially less than the height of the ridges in the base. In some such embodiments the depth of the recesses in the lid is at least 10% less than the height of the ridges in the base. In some such embodiments the depth of the recesses in the lid is at least 25% less than the height of the ridges in the base. In some such embodiments the depth. of the recesses in the lid is at least 50% less than the height of the ridges in the base. In some such embodiments the depth of the recesses in the lid is at least 75% less than the height of the ridges in the base.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A cookware object comprising:
a base, said base including raised ridges and recessed channels designed to hold a liquid; and
a lid that fits onto said base.

2. The cookware object as claimed in claim 1 wherein a diameter of the cookware object, a displacement of the ridges and a height of the ridges are designed to allow for the introduction of sufficient fluid into the object to promote steam while cooking, while at the same time separating the item being cooked from the liquid by holding the item on top of the ridges.

3. The cookware object as claimed in claim 2 wherein the cookware object is designed to hold 250 ML of water at room temperature.

4. The cookware object as claimed in claim 1 wherein said lid includes recesses generally coinciding with said ridges of said base.

5. The cookware object as claimed in claim 1 further including a fill indicator on said base to show a maximum level to which liquid should be added to said base.

6. The cookware object as claimed in claim 1 wherein said channels are sloped generally downward from the perimeter of the base inward toward the center of the base.

7. The cookware object as claimed in claim 1 wherein said channels are sloped generally downward from the center of the base outward toward the perimeter of the base.

8. The cookware object as claimed in claim 1 wherein a bottom of said base is generally convex.

9. The cookware object as claimed in claim 8 wherein said channels are sloped generally downward from a center of said base outward toward a perimeter when said bottom is convex, and wherein said slop lessens as said bottom flattens during heating of said object.

10. The cookware object as claimed in claim 1 wherein said lid includes a vapor seal.

11. The cookware object as claimed in claim 10 wherein said vapor seal includes a shoulder of said base.

12. A method of cooking comprising the steps of:
placing an item to be cooked in a cookware object that includes ridges on top of which the item is positioned;
adding a small amount of liquid to the cookware object, such that said liquid level is below said top of said ridges;
placing a lid on said cookware object; and
heating said cookware object to produce steam within said object.

13. The method as claimed in claim 12 wherein the amount of water is 250 ml or less.

14. The method as claimed in claim 13 wherein the amount of water is generally a spoonful.

15. The method as claimed in claim 12 wherein said lid includes a vapor seal.

16. The method as claimed in claim 15 wherein said vapor seal includes a shoulder of the base.
